(19) United States
(12) Patent Application Publication
(10) Pub. No.: US 2018/0117779 A1
(43) Pub. Date: May 3, 2018

(54) Knife with Fire Starting Implement

(71) Applicant: Michael John Mojica, Englewood, CO (US)

(72) Inventor: Michael John Mojica, Englewood, CO (US)

(21) Appl. No.: 15/340,894

(22) Filed: Nov. 1, 2016

(51) Int. Cl. B26B 11/00; B26B 3/00; B26B 9/02; F23Q 1/06

(52) U.S. Cl. CPC B26B 11/00; F23Q 1/06; B26B 9/02; B26B 3/00

(57) ABSTRACT

The invention relates to a novel knife with fire igniting capabilities as part of the knife itself. More specifically, the present invention provides for both a knife, and fire starting capability in one piece, which are both crucial to outdoor survival and useful in general camping and hiking activities. The handle can be hollow to contain a small survival kit, and the grips can be wrapped in paracord for other multiple outdoor survival uses.

### CROSS REFERENCES TO RELATED APPLICATIONS

This Application claims benefit to Provisional Application 62/240,478 filed on Oct. 12, 2015 for the invention disclosed herein.

### FIELD

The invention relates to a novel knife with fire igniting capabilities as part of the knife itself. More specifically, the present invention provides for both a knife, and fire starting capability in one piece, which are both crucial to outdoor survival and useful in general camping and hiking activities.

### BACKGROUND OF THE INVENTION

The invention most closely corresponds with USPTO Class D07/642 wherein Class D07 relates to knife design, and sub-class 642 includes a knife or blade. Additionally, Class and subclass 431/273 wherein Class 431 includes flints and subclass 273 includes lighters.

The invention discloses a single-bladed knife with fire starting capabilities housed within the knife itself. The knife may be a fixed blade or folding design with a fabric, leather or vinyl grip.

It is widely held that if you are lost in the woods or battling the elements, the key piece of equipment to have is a good survival knife. Survival knives not only act as durable tools to cut down branches or skin animals, but they can also be the difference between life and death. The inventive knife also provides fire starting capability which combines with the other useful features of a survival knife to add significant utility.

### SUMMARY, OBJECTS AND ADVANTAGES

The preferred embodiment of the present invention is essentially comprised of a sparking and/or combustible material assembled with a spring and friction or spark wheel housed within the handle of the knife. This could be a hunting type knife or any knife utilized in outdoor activities such as camping or hiking where the need to ignite fires relates to an appropriate amount of gear a user carries. In the instance of backpacking, the lighter the load, the more ideal or even crucial to the user. The present inventive knife has contouring useful for cutting, sawing or prying.

The sparking material may be made of ferrocerium or flint or other sparking elements. The friction portion in the form of a wheel is in close proximity to the sparking element embodied in the knife handle housing. The wheel may be made of high carbon steel or other material that will generate sparks or combustion when rubbed with the combustible or sparking portion. The spark wheel is rotated by a user and can accomplished with one hand. The spark wheel is aligned so that it is contact with the flint/ferrocerium. When the spark wheel is rotated, sparks are generated by the flint and projected to an ignition or fire creation area at the end of the knife handle. The fire-starting elements are located opposite the knife blade for added safety.

Another embodiment of the present invention is that the knife may also have a hollow handle which can house a small survival kit. A user can designate what to place in a kit, but typical items would be a compass, bandages, matches or the like. In the present invention, there is no need for fire starting mechanisms because the knife provides that feature within its frame.

A further embodiment is wherein the knife handle is comprised of fabric in the form of a wrapped paracord. Paracord is typically a nylon rope that offers significant strength yet is not heavy or cumbersome. In the outdoors paracord can be used to create a fishing line or to secure gear, among other numerous uses.

Whether climbing or camping, there is always a need for a way to make a fire. This could mean survival or not in an overnight situation in extreme conditions. Climbing and backpacking both require specific gear, and the need to keep the load light. The inventive knife with fire starting implement is a valuable and novel way to utilize one piece of equipment for multiple purposes. A user may apply the function of lighting material, optionally cutting material, or utilizing the attached paracord as fishing line or to secure gear.

### BRIEF DESCRIPTION OF THE DRAWINGS

The invention is disclosed in the following drawings which are sufficient to disclose the nature of the invention and embodiments claimed.

FIG. 1 is a bi-sectional view of the knife with fire starting implement;

FIG. 2 is a left side perspective of the knife with fire starting implement;

FIG. 3 is an isometric view of the knife with fire starting implement;

FIG. 4 is an exploded view of the knife showing the combustion pieces;

FIG. 5 is an exploded view of the view of the knife with fire-starting portions and handle;

FIG. 6 is a left side perspective of the knife with contoured blade; and

### DETAILED DESCRIPTION, INCLUDING BEST MODES OF CARRYING OUT THE INVENTION

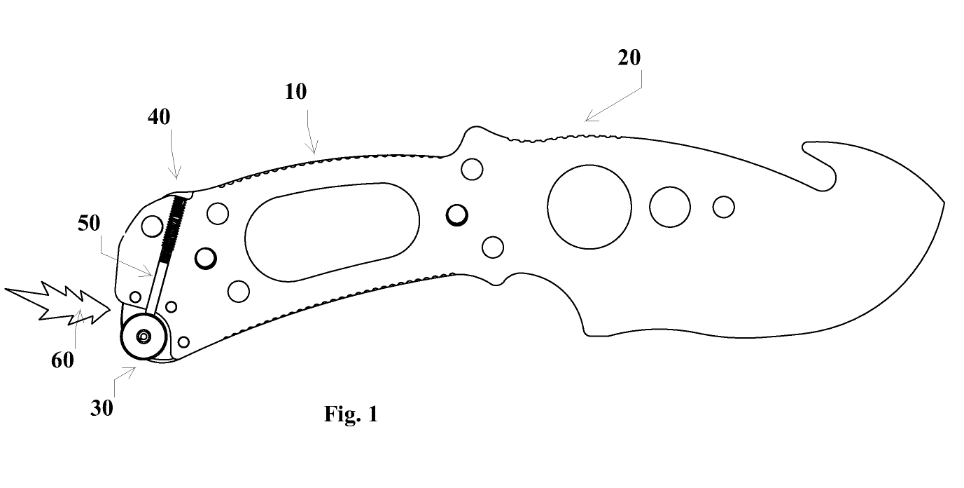

FIG. 1 is a bisectional view of the knife. The handle 10 will house the spring and set pin 40. The spring places pressure on the ferro rod 50, and the ferro rod is forced against the spark wheel 30 when a user rotates the spark wheel. The resultant friction creates sparks 60 for igniting material. The blade 20 is shown with contouring.

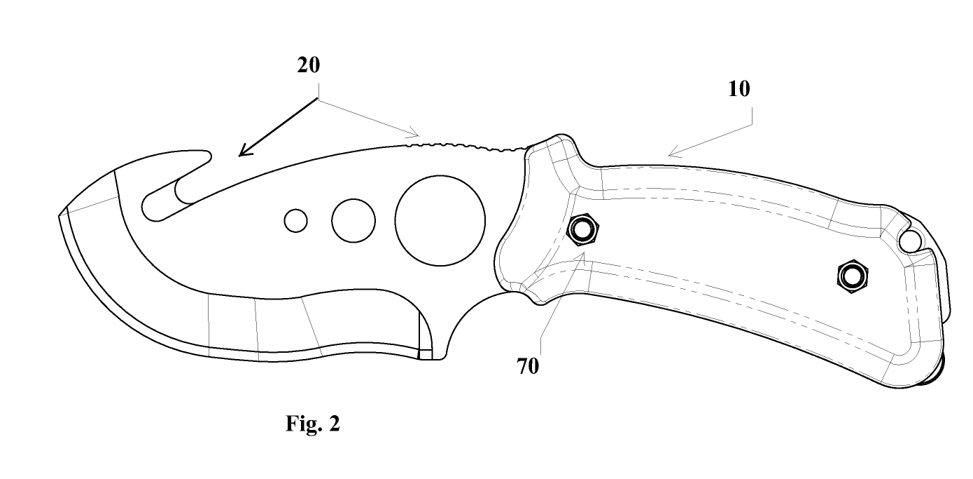

FIG. 2 is another bisectional view of the knife. The blade 20 shows the contours which have utility when cutting various materials or even use for prying items one from another. The grip 100 is affixed by screws 70, and can be fabric, leather or a vinyl material.

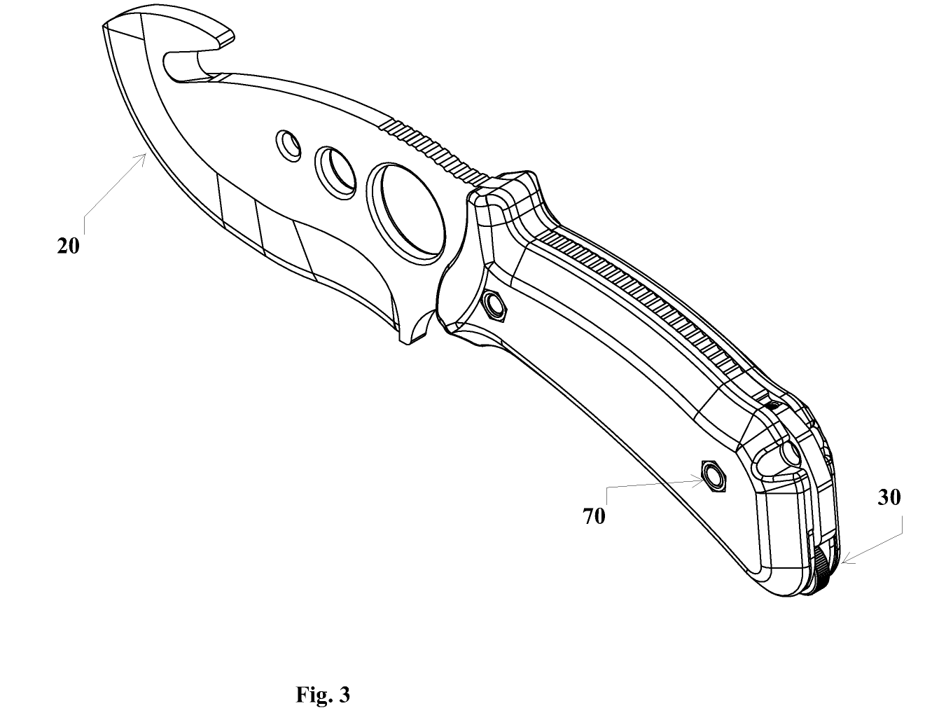

FIG. 3 is an isometric view of the knife, again showing the blade 20 with contouring. The handle 10 is shown with both sides attached by the screws 70. The spark wheel 30 can be seen extruding from the knife handle wherein the ferro rod and spring are not shown in this Figure.

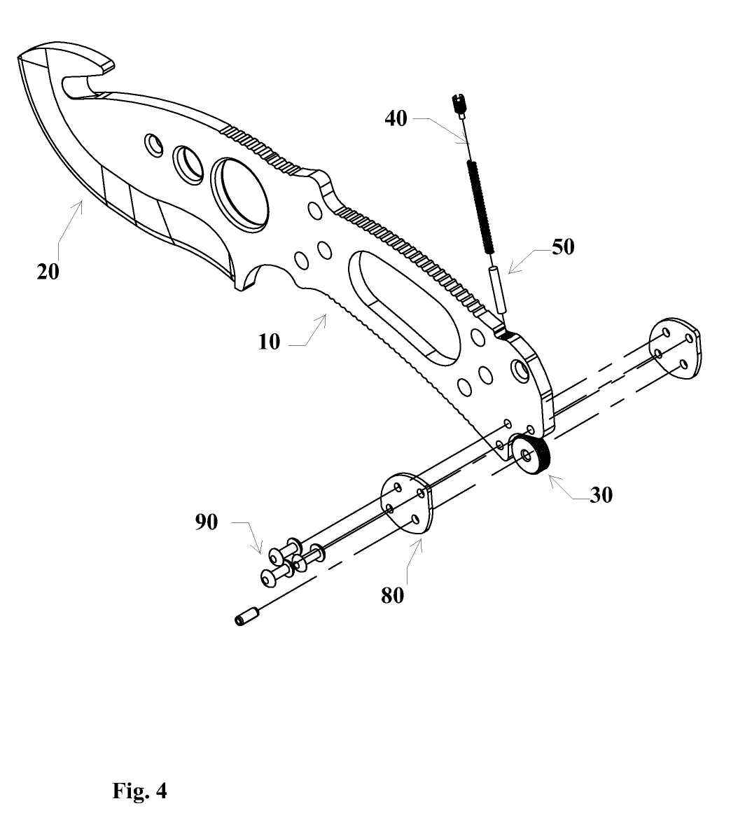

FIG. 4 is an exploded isometric view of the knife showing the blade 20 with contouring. The grip is not shown in this Figure to allow illustration of the placement of the fire-starting implements. The set screw and spring 40 are located within the knife frame and will be obscured once a grip is affixed to the handle 10. A set of plates 80 clasp to each side of the frame with rivets 90 to hold the spark wheel in place while allowing for its rotation around one of the rivets 90.

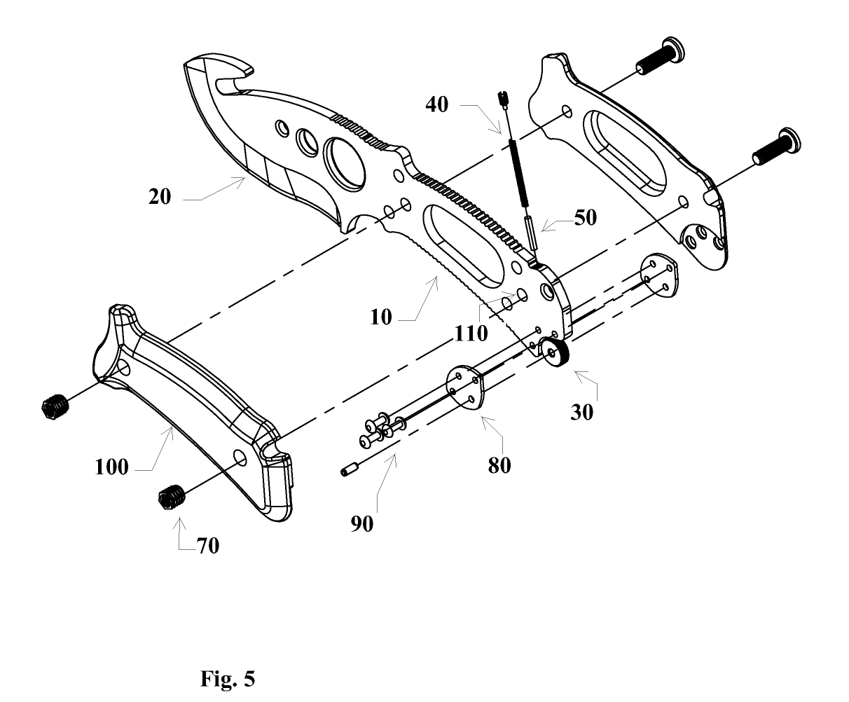

FIG. 5 is an exploded isometric view showing the blade with contouring 20. The grip portions 100 are illustrated and are affixed to the knife handle 10 with screws 70 which go through apertures in the knife handle 110 created therefor. The rivets 90 insert through apertures 110 in the knife handle created theorfor and connect the plates 80 to the handle to hold the spark wheel 30 to the frame while allowing the wheel to be rotated. The ferro rod 50 and spring and set pin 40 are again shown.

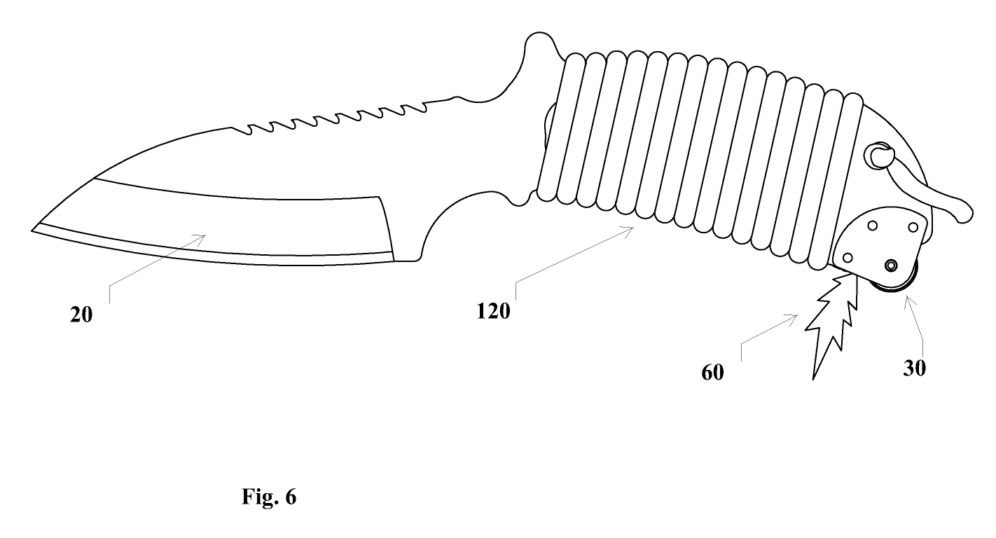

FIG. 6 is a left side view showing the blade with contouring 20. The grip 100 in this embodiment has nylon paracord 120 wrapped therearound which can be unwound from the knife for utility purposes commensurate with those offered by paracord. The spark wheel 30 is against shown at the base of the handle where it creates sparks 60 for igniting material.

1) A knife with fire starting implement comprising:
a) a handle portion with grip
b) a blade portion
c) a spark wheel located within the knife handle
d) a ferro rod compressed by a spring and set screw located within the knife handle.

2) The knife with fire starting implement of claim 1 wherein the handle portion has a grip wherein said grip is composed of fabric or leather and is affixed with screws.

3) The knife with fire starting implement of claim 1 wherein the blade portion can have a straight or serrated edge and can be fixed or folded inward to the handle.

4) The knife with fire starting implement of claim 1 wherein a spark wheel is contained within the handle of the knife for providing friction to the ferro rod

5) The knife with fire starting implement of claim 1 wherein the ferro rod is compressed by a spring and set screw which resides within the knife handle and wherein the set screw holds the spring and ferro rod therein, and will react to the spark wheel rotation to produce sparks for igniting material.

5) A knife with fire starting implement wherein the handle of the knife can be hollow and receive a small survival kit stored therein without interfering with the ferro rod and spring components.
